(19) United States
(12) Patent Application Publication
(10) Pub. No.: US 2001/0018119 A1
(43) Pub. Date: Aug. 30, 2001

(54) Foamed sheet and method for producting the same

(76) Inventors: Takeshi Minaba, Toyonaka-shi (JP); Koji Yamatsuta, Otsu-shi (JP); Yoshinori Ohmura, Hirakata-shi (JP)

Correspondence Address: Pillsbury Madison & Sutro LLP, Intellectual Property Group, East Tower, Ninth Floor, 1100 New York Avenue, N.W., Washington, DC, 20005-3918, US

(21) Appl. No.: 09/771,950

(22) Filed: Jan. 30, 2001

(30) Foreign Application Priority Data
Feb. 10, 2000 (JP) 2000-033296

(51) Int. Cl. B32B 3/26

(52) U.S. Cl. 428/304.4; 428/314.2

(57) ABSTRACT

The present invention provides a foamed sheet showing small dimensional changes resulted with temperature changes, etc., said foamed sheet which made of a thermoplastic resin material, wherein the coefficient of linear expansion of the thermoplastic resin material α (/°C.) and the coefficient of linear expansion of the foamed sheet α_{f} (/°C.) satisfy the following expression (1):

|α_{f}/α|≦½ (1)

and the like.

### BACKGROUND OF THE INVENTION

1. Field of the Invention

The present invention relates to foamed sheets that show small dimensional changes resulted with temperature changes, etc.

2. Description of the Prior Art

Heretofore, a number of foamed sheets are known. For example, there are known those produced by a method comprising extruding a foamable resin material into a sheet form through a forming die at the same time making it foam, or those produced by a method comprising extruding a foamable resin material into a sheet form through a forming die and foaming the extruded sheet by further heating. All of these conventional foamed sheets have extremely high linear expansion coefficients and show great dimensional changes with temperature changes, so they are unsuitable for applications where high dimensional stability is required. For example, when thin tatami mats in which the conventional foamed sheet is used as a core material (a tatami base) are laid on a floor of house, the foamed sheet expends in every direction with temperature rise. As a result, the tatami mats get longer and adjoining tatami mats push each other so that there occurs a phenomenon in which the ends of the tatami mats thrust up. Moreover, in the case of laminates composed of the conventional foamed sheet and a metallic plate, since the foamed sheet shows greater dimensional changes with temperature changes than the metallic plate, there is a problem that the metallic plate is liable to peel off from the foamed sheet or the laminate is liable to warp.

### SUMMARY OF THE INVENTION

The object of the present invention is to provide foamed sheets that show small dimensional changes with temperature changes and do not cause problems like those mentioned above in their use in the aforementioned applications.

As the result of researches for solving the aforementioned problems, the resent inventors have reached the following invention.

A first embodiment of the present invention is a foamed sheet made of a thermoplastic resin material wherein the linear expansion coefficient α (/°C.) of the thermoplastic resin material and the linear expansion coefficient α_{f} (/°C.) of the foamed sheet satisfy the following expression (1):

|α_{f}/α|≦½ (1)

Since a foamed sheet made of a thermoplastic resin material having such a feature has a linear expansion coefficient greatly reduced than that of the thermoplastic resin material in a non-foamed non-stretched state which is the material of the foamed sheet, the foamed sheet shows small dimensional changes with temperature changes and therefore can be suitably used for applications where high dimensional stability is required.

Moreover, after the finding that a linear expansion coefficient of a foamed sheet is closely related with the specific shape of the cells present in a specific part in the foamed sheet, the present inventors have reached a second embodiment of the present invention. That is, the second embodiment of the present invention is a foamed sheet made of a thermoplastic resin material wherein at least cells present in one pair of cross-sections along thickness directions of the foamed sheet, the cross-sections being perpendicular to each other, satisfy the following expression (2):

Lₘₐₓ/Lₘᵢₙ≧4.5 (2)

wherein Lₘₐₓ and Lₘᵢₙ represent the maximum value and the minimum value, respectively from a total of the four average values (the average values of the cells for X or Y direction on the A or B cross-section) which are obtained by the following procedures including:

extracting ten cells at random for each of two cross-sections (A cross-section and B cross-section) of the foamed sheet along thickness directions thereof, the cross-sections being perpendicular to each other,

measuring, for each of the extracted cells, the size of a cell in a sheet thickness direction (X direction) and that in a direction (Y direction) parallel to the sheet surfaces and,

calculating, for each of the directions (X direction and Y direction) on each of the cross-sections (A cross-section and B cross-section), the average value of the sizes of the cells.

Since a foamed sheet made of a thermoplastic resin material having such a feature has a linear expansion coefficient greatly reduced than that of the thermoplastic resin material in a non-foamed non-stretched state which is the material of the foamed sheet, the foamed sheet shows extremely small dimensional changes with temperature changes and therefore can be suitably used for applications where high dimensional stability is required.

In addition, the present invention also provides a foamed sheet having a particularly desirable specific cell structure. The foamed sheet is characterized in that it is obtainable by foaming a foamable thermoplastic resin material plasticated in an extruder while extruding it in a sheet form through a die connected to the extruder and drawing down the extruded sheet-shaped matter at a draw ratio of 1.7 or more.

Since a foamed sheet made of a thermoplastic resin material having such a feature has a linear expansion coefficient greatly reduced than that of the thermoplastic resin material in a non-foamed non-stretched state which is the material of the foamed sheet, the foamed sheet shows extremely small dimensional changes with temperature changes and therefore can be suitably used for applications where high dimensional stability is required.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integer or step.

### BRIEF DESCRIPTION OF THE DRAWINGS

FIG. 1 is a view showing a surface and a partial cross-section of a foamed sheet of the present invention. In the figure, Signs “1” and “1” mean a cross-section (A cross-section) of the foamed sheet along thickness directions thereof, the cross-section being perpendicular to the other, and Signs “2” and “2” mean a cross-section (B cross-section) of the foamed sheet along thickness directions thereof, the cross-section being perpendicular to the other. Signs “3” and “3” mean a sheet thickness direction (X direction) and Signs “4” and “4” mean a direction (Y direction) parallel to the sheet surfaces.

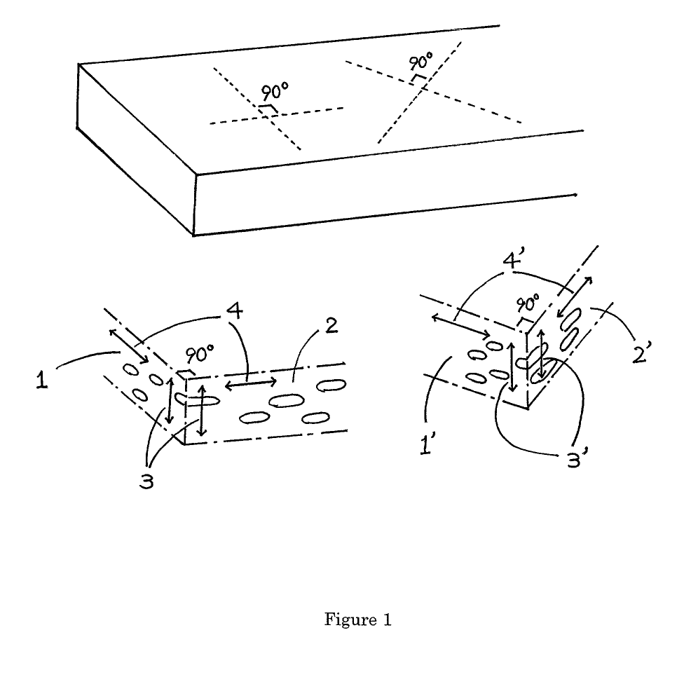

### DESCRIPTION OF THE PREFERRED EMBODIMENTS

The first embodiment of the present invention is a foamed sheet made of a thermoplastic resin material wherein the linear expansion coefficient α (/°C.) of the thermoplastic resin material and the linear expansion coefficient α_{f} (/°C.) of the foamed sheet satisfy the following expression (1):

|α_{f}/α|≦½ (1)

The foregoing foamed sheet is characterized in that it has a linear expansion coefficient of less than or equal to ½ of that of the thermoplastic resin material in a non-foamed non-stretched state which is the material of the foamed sheet. The above expression (1) is only required to be satisfied for a direction parallel to the surfaces of the foamed sheet (a direction perpendicular to a thickness direction). The value of |α_{f}/α| is preferably ⅓ or less. Although the value of |α_{f}/α| is greater than zero, it is as small as possible considering in the light of the object of the present invention.

The foamed sheet of the present invention having such a feature has a low linear expansion coefficient and therefore can be suitably used for applications where foamed sheets are required to show small dimensional changes with temperature changes.

The foamed sheet according to the second embodiment of the present invention is characterized in that at least cells present in one pair of cross-sections along thickness direction of the foamed sheet, the cross-sections being perpendicular to each other satisfy the following expression (2):

Lₘₐₓ/Lₘᵢₙ≧4.5 (2)

wherein Lₘₐₓ and Lₘᵢₙ represent the maximum value and the minimum value, respectively from a total of the four average values (the average values of the cells for X or Y direction on the A or B cross-section) which are obtained by the following procedures including:

extracting ten cells at random for each of two cross-sections (A cross-section and B cross-section) of the foamed sheet along thickness directions thereof, the cross-sections being perpendicular to each other,

measuring, for each of the extracted cells, the size of a cell in a sheet thickness direction (X direction) and that in a direction (Y direction) parallel to the sheet surfaces and

calculating, for each of the directions (X direction and Y direction) on each of the cross-sections (A cross-section and B cross-section), the average value of the sizes of the cells.

The value of ratio (Lₘₐₓ/Lₘᵢₙ) is preferably 4.5 or more, more preferably 5.0 or more, and particularly preferably 5.5 or more.

The linear expansion coefficient of the foamed sheet tends to decrease with the increase of ratio (Lₘₐₓ/Lₘᵢₙ) and the upper limit of the ratio is not particularly limited. However, usually, when the value of the ratio exceeds about 7, the effect of reducing a linear expansion coefficient becomes almost constant. Thus the above ratio is usually set at 7 or less.

The foamed sheets of the present invention having such a feature have a low linear expansion coefficients and therefore can be suitably used for applications where foamed sheets are required to show small dimensional changes with temperature changes.

The foamed sheet of the present invention is made of a thermoplastic resin material and the thermoplastic resin material comprises at least one kind of thermoplastic resin. The kind of the thermoplastic resin which constitutes the thermoplastic resin material is not particularly limited as long as it can form foams. For example, polyolefin resins such as high, medium or low density polyethylene and polypropylene, polystyrene resin, acrylic resin such as poly(methyl methacrylate), polyamide resin, polyester resin and poly(vinyl chloride) resin may be employed. Non-crosslinked thermoplastic resins are preferable since they can be easily recycled. The thermoplastic resins may be either homopolymers or copolymers. When two or more kinds of thermoplastic resins are used, the mixing proportion of the resins is not particularly limited. Moreover, copolymers are not limited in their monomer compositions.

The foamed sheet of the present invention may contain additives such as antioxidants, ultraviolet absorbers, antistatic agents, anti-lubricating agents and lubricants as long as neither foamability in the production of the foamed sheet nor the performance of the foamed sheet is damaged. For example, an amount of the additives may be not more than 20 weight % of the foamed sheet. In addition, the foamed sheet may also contain fillers such as talc, mica, glass fiber and wooden fiber. For example, an amount of the fillers may be not more than 20 weight % of the foamed sheet. As fillers particularly effective for achieving lower linear expansion coefficients, for example, fibrous fillers such as glass fiber and wooden fiber may be mentioned.

The foamed sheet of the present invention is not particularly limited with regard to the shape thereof and may be, for example, in a tubular form as well as a typical sheet form. Although there is no critical limitation about the thickness of the foamed sheet, the thickness is usually 0.5 mm or more, preferably 0.8 mm or more. If the foamed sheet is thinner than 0.5 mm, there is a tendency that cells are liable to break.

The foamed sheet of the present invention is not particularly limited about its expansion ratio.

The foamed sheet of the present invention may be produced by modified applications of known methods such as the atmospheric pressure heating method, the extrusion foaming method, the compression foaming method and the injection foaming method using foamable thermoplastic resin materials. For example, it may be produced by stretching, to about three times or more, a foamed sheet made of a thermoplastic resin material prepared by a general method using a foamable thermoplastic resin material after heating the intermediate foamed sheet so that its surface temperature reaches about 160° C. Moreover, it is important to keep the surface temperature of the intermediate foamed sheet in such a temperature range that cells in the foamed sheet do not break during the production. The foamed sheet of the present invention may also be produced by a method in which a take-up speed (i.e. draw-down speed) of a foamble thermoplastic resin material discharged in the form of sheet from a die connected to an extruder is larger than a discharging speed of resin at the die in the production of a foamed sheet by the expansion foaming method. This production method is preferable since it can be carried out using a shorter production line than the well-known stretching method. Moreover, when producing foamed sheets having particularly desirable specific cell structures, it is important to draw down an extruded sheet-shaped matter at a draw ratio of 1.7 or more, preferably 1.9 or more. The draw ratio (DR) is calculated from the following expression (3). In the expression, Tr denotes the thickness (mm) of the foamed sheet finally obtained, Ti denotes the hypothetical thickness (mm) of a foamed sheet right after its discharge from a die, X denotes an expansion ratio, t denotes a die lip opening (mm) and SR denotes a swell ratio of the thermoplastic resin material used.

DR=Ti/Tr (3)

Ti=X·t·SR

The foamable thermoplastic resin material may be prepared by mixing a foamable material and optionally some additives such as antioxidants, ultraviolet absorbers, antistatic agents, anti-lubricating agents, lubricants and fillers to a thermoplastic resin using a mixing device such as an extruder. Examples of the fillers include talc, mica glass fiber, wooden fiber and the like. For example, an amount of the additives may be not more than 20 weight % of the foamable thermoplastic resin material. As the foamable material, physical foaming agents and chemical foaming agents are applicable. The physical foaming agent may be water, carbon dioxide, hydrocarbons and freons. The chemical foaming agent may be inorganic foaming agents such as sodium bicarbonate and organic foaming agents such as azodicarbonamide. Moreover, the foamable material may be combinations of plural foaming agents and also may be combinations of physical foaming agents and chemical foaming agents. In addition, the foamable material may be combinations of foaming aids such as zinc oxide and the aforementioned foaming agents. Furthermore, the foamable material may be compositions prepared by mixing any of these foamable materials to a matrix such as resin in high concentrations (for example, 30 weight %), which are called “master batches.”

Since the foamed sheet of the present invention has a greatly reduced linear expansion coefficient than that of the non-foamed non-stretched thermoplastic resin material which is the material of the foamed sheet, it shows small dimensional changes with temperature changes. Therefore, by utilizing the foamed sheet of the present invention for materials of tatami bases, various kinds of building materials, automobile ceiling materials and various kinds of automobile parts, it is possible to obtain structural materials which show small dimensional changes with temperature changes. Such structural materials may be composed only of the foamed sheet of the present invention and also may be composed of the foamed sheet of the present invention and other materials laminated thereto in order to have desired functions and performance such as designability and rigidity.

According to the present invention, foamed sheets can be provided which show small dimensional changes with temperature changes, causing no problems like those mentioned above even though they are combined with other structural materials such as metal and wood. Such foamed sheets of the present invention are suitable for applications that require excellent dimensional stability with respect to temperature.

The present invention is further explained by the following examples in detail, but the invention is not limited to these examples.

First, methods for the measurement of physical properties and those for the evaluation of effects used in the following Examples and Comparative examples are described.

(1) Expansion ratio and thickness of a foamed sheet

An expansion ratio of a foamed sheet made of a thermoplastic resin material was determined by cutting the foamed sheet and a non-foamed sheet made of the same thermoplastic resin material as that of the foamed sheet into a size of 50 mm in width and 50 mm in length, measuring their specific gravities by the displacement-in-water method, and calculating the expansion ratio by the following expression using the measurements of specific gravities.

Expansion ratio=(Specific gravity of a non-foamed sheet)/(Specific gravity of a foamed sheet)

In addition, a thickness of a foamed sheet was measured with a vernier caliper.

(2) Draw ratio (DR)

A draw ratio was calculated according to the following expression (3). In the expression, Tr denotes a thickness (mm) of a foamed sheet, Ti denotes a thickness (mm) of the foamed sheet right after its discharge from a die, X denotes an expansion ratio of the foamed sheet, t denotes a die lip opening (mm) and SR denotes a swell ratio of the thermoplastic resin material used.

DR=Ti/Tr (3)

Ti=X·t·SR

(3) Shape of cells

A foamed sheet was cut along its two thickness direction perpendicular to each other. The two cross-section (A cross-section and B cross-section) were magnified in 200 times with a microscope and were photographed. In the observation of the photographs, for each of the cross-sections (A cross-section and B cross-section), ten cells were extracted at random from the cells present in the interior region of the foamed sheet apart from the surfaces of the foamed sheet by a distance greater than 10% of the whole thickness of the foamed sheet and, for each cell extracted, the size in the sheet thickness direction (X direction) and that in the direction (Y direction) parallel to the sheet surfaces were measured, respectively. Average values of the sizes of the cells extracted were calculated for each of the directions (X direction and Y direction) on each of the cross-sections (A cross-section and B cross-section). Letting the maximum value and the minimum value of the resulting four average values (the average cell size in A cross-section in X direction, the average cell size in A cross-section in Y direction, the average cell size in B cross-section in X direction and the average cell size in B cross-section in Y direction), respectively, be Lₘₐₓ and Lₘᵢₙ, a ratio of Lₘₐₓ to Lₘᵢₙ (Lₘₐₓ/Lₘᵢₙ) was calculated. The ratio was used as an index of the shape of cells.

(4) Linear expansion coefficient

A foamed sheet was cut into a rectangle measuring 250 mm in length and 20 mm in width and marked lines (straight lines) were drawn in a surface of the cut sample at a 240-mm interval in the longitudinal direction of the cut sample. The cut sample was heated from 23° C. to 53° C. and then cooled to 23° C. During this operation, the length of the interval between the marked lines at 53° C. and that at 23° C. after heating and cooling were measured, respectively. Using the measurements of the length of the interval between the marked lines, the linear expansion coefficient of the foamed sheet was calculated by the following expression:

Linear expansion coefficient (/°C.)={(L₅₃−L₂₃)/L₂₃}/(53-23)

L₂₃: Length of the interval between the marked lines at 23° C.

L₅₃: Length of the interval between the marked lines at 53° C.

(5) Thrust-up evaluation of a tatami mat

Two pieces of tatami mats are butted together in their longitudinal directions and fixed to a wooden fixing jig 2 mm shorter than the total length of the two tatami mats. The fixing jig and the two tatami mats fixed thereto were heated from 25° C. (the temperature in fixation) up to 50° C. and then they were held at this temperature. After one hour, the condition of the tatami mats was observed. The evaluation standard is as follows:

X: Thrust-up was observed.

◯: Thrust-up was not observed.

### EXAMPLE 1

A foamed sheet was prepared by processing, by the extrusion foaming method under the following conditions, a resin composition obtained by mixing 2.6 parts by weight, as a master batch, of a master batch containing a foaming agent with 100 parts by weight of a mixture of a polypropylene resin and a polyethylene resin [polypropylene resin/polyethylene resin (weight ratio)=85/15; a swell ratio (SR)=3.5; a linear expansion coefficient (/°C.)=10×10⁻⁵]. As the foaming agent was used a 30-weight % master batch (matrix: a polyethylene resin) of a composite foaming agent having a composition of sodium bicarbonate/azodicarbonamide/zinc oxide=9/0.5/0.5 (weight %).

Expansion foaming conditions

Extruder: 120 mm φ extruder

The rate of rotation of screw: 17 rpm

Cylinder temperature: 200° C.

Die width: 1500 mm

Die lip opening: 0.3 mm

Die temperature: 190° C.

Sheet take-up speed: 3.2 m/min

The resulting foamed sheet had an expansion ratio of 2.0 times and a thickness of 1.1 mm. Moreover, a draw ratio (DR) calculated by expression (3) was 1.9. An Lₘₐₓ/Lₘᵢₙ ratio that expresses a shape of cells was 6.4. A linear expansion coefficient α_{f} of the foamed sheet was 3.4×10⁻⁵ (/°C.) for the extrusion direction (MD) and 4.7×10⁻⁵ (/°C.) for the direction (TD) perpendicular to the extrusion direction. A value of |α_{f}/α| was 0.34 for the MD and 0.47 for the TD. These results are shown in Table 1.

Using this foamed sheet, a thin tatami mat was produced. A tatami base was first produced by integrally sewing two foamed sheet measuring 1820 mm in width and 910 mm in length cut from the above-obtained foamed sheet on both sides of a T-grade insulation fiber board measuring 1820 mm in width, 910 mm in length and 7 mm in thickness. A thin tatami mat 15 mm in whole thickness was then produced by sewing a tatami surface on the tatami base. After the observation of whether thrust-up occurs using two tatami mats produced above, no thrust-up was observed. The evaluation result is shown in Table 1.

### EXAMPLE 2

A foamed sheet was prepared in the same manner as Example 1 except using 3.8 parts by weight of the foaming agent. The foamed sheet had an expansion ratio of 2.8 times and a thickness of 1.4 mm. Moreover, a draw ratio (DR) calculated by expression (3) was 2.1. Evaluation results of the resulting foamed sheet are shown in Table 1.

A thin tatami mat was made in the same manner as Example 1 except using this foamed sheet. Its evaluation result is shown in Table 1.

### Comparative Example 1

A foamed sheet was prepared by processing, by the extrusion foaming method under the following conditions, a resin composition obtained by mixing 3.2 parts by weight, as a master batch, of a master batch containing a foaming agent with 100 parts by weight of a mixture of a polypropylene resin and a 1-butene/ethylene copolymer [polypropylene resin/1-butene/ethylene copolymer (weight ratio)=85/15; a swell ratio (SR) =1.9; linear expansion coefficient (/°C.)=10×10⁻⁵]. As the foaming agent was used a 30-weight % master batch (matrix: a polyethylene resin) of a composite foaming agent having a composition of sodium bicarbonate/azodicarbonamide/zinc oxide=9/0.5/0.5 (weight %).

Expansion foaming conditions

Extruder: 120 mm φ extruder

The rate of rotation of screw: 30 rpm

Cylinder temperature: 170° C.

Die width: 1500 mm

Die lip opening: 0.5 mm

Die temperature: 170° C.

Sheet take-up speed: 2.2 m/min

The resulting foamed sheet had an expansion ratio of 2.7 times and a thickness of 2.9 mm. Moreover, a draw ratio (DR) calculated by expression (3) was 0.8. Evaluation results of the resulting foamed sheet are shown in Table 1.

A thin tatami mat was made in the same manner as Example 1 except using this foamed sheet. Its evaluation result is shown in Table 1.

### Comparative Example 2

A foamed sheet was prepared in the same manner as Comparative example 1 except that 1.5 parts by weight of the foaming agent was used and a part of extrusion foaming conditions were changed as follows.

Expansion foaming conditions

The rate of rotation of screw: 29 rpm

Die lip opening: 0.6 mm

Sheet take-up speed: 3.0 m/min

The resulting foamed sheet had an expansion ratio of 1.2 times and a thickness of 1.2 mm. Moreover, a draw ratio (DR) calculated by expression (3) was 1.1. Evaluation results of the resulting foamed sheet are shown in Table 1.

A thin tatami mat was made in the same manner as Example 1 except using this foamed sheet. Its evaluation result is shown in Table 1.

### Comparative Example 3

A foamed sheet was produced in the same manner as Comparative example 1 except that 1.6 parts by weight of the foaming agent was used and a part of extrusion foaming conditions were changed as follows.

Expansion foaming conditions

The rate of rotation of screw: 25 rpm

Die lip opening: 0.5 mm

Sheet take-up speed: 3.2 m/min

The resulting foamed sheet had an expansion ratio of 1.6 times and a thickness of 1.1 mm. Moreover, a draw ratio (DR) calculated by expression (3) was 1.4. Evaluation results of the resulting foamed sheet are shown in Table 1.

A thin tatami mat was made in the same manner as Example 1 except using this foamed sheet. Its evaluation result is shown in Table 1.

TABLE 1

| | | | | | Linear | | | | Thrust up |
|---|---|---|---|---|---|---|---|---|---|
| | | | | | expansion | | | | Evaluation |
| | | | | | coefficient | | | | of |
| | Expansion | Thickness | Draw | | ×10⁻⁵ (/° C.) | | \|α_{f}/α\| | | tatami |
| | ratio | (mm) | ratio | Lₘₐₓ/Lₘᵢₙ | MD | TD | MD | TD | mat |
| Example | 2.0 | 1.1 | 1.9 | 6.4 | 3.4 | 4.7 | 0.34 | 0.47 | ◯ |
| 1 | | | | | | | | | |
| Example | 2.8 | 1.4 | 2.1 | 5.5 | 3.6 | 4.7 | 0.36 | 0.47 | ◯ |
| 2 | | | | | | | | | |
| Comparative | 2.7 | 2.9 | 0.8 | 2.1 | 11 | 11 | 1.1 | 1.1 | X |
| Example | | | | | | | | | |
| 1 | | | | | | | | | |
| Comparative | 1.2 | 1.2 | 1.1 | 3.1 | 9.1 | 9.1 | 0.91 | 0.91 | X |
| Example | | | | | | | | | |
| 2 | | | | | | | | | |
| Comparative | 1.6 | 1.1 | 1.4 | 4.0 | 7.8 | 7.8 | 0.78 | 0.78 | X |
| Example | | | | | | | | | |
| 3 | | | | | | | | | |

What is claimed is:

1. A foamed sheet made of a thermoplastic resin material, wherein the coefficient of linear expansion of the thermoplastic resin material α (/°C.) and the coefficient of linear expansion of the foamed sheet α_{f} (/°C.) satisfy the following expression (1):

|α_{f}/α≦½ (1)

2. A foamed sheet made of a thermoplastic resin material, wherein at least cells present in one pair of cross-sections along thickness directions of the foamed sheet, the cross-sections being perpendicular to each other, satisfy the following expression (2):
Lₘₐₓ/Lₘᵢₙ≧4.5 (2)
wherein Lₘₐₓ and Lₘᵢₙ represent the maximum value and the minimum value, respectively from a total of the four average values (the average values of the cells for X or Y direction on the A or B cross-section) which are obtained by the following procedures including:
extracting ten cells at random for each of two cross-sections (A cross-section and B cross-section) of the foamed sheet along thickness directions thereof, the cross-sections being perpendicular to each other,
measuring, for each of the extracted cells, the size of a cell in a sheet thickness direction (X direction) and that in a direction (Y direction) parallel to the sheet surfaces and
calculating, for each of the directions (X direction and Y direction) on each of the cross-sections (A cross-section and B cross-section), the average value of the sizes of the cells.

3. The foamed sheet according to claim 2, which is obtainable by foaming a foamable thermoplastic resin material plasticated in an extruder while extruding it in a sheet form through a die connected to the extruder and drawing down the extruded sheet-shaped matter at a draw ratio of 1.7 or more.
